(19) United States
(12) Patent Application Publication
(10) Pub. No.: US 2011/0053051 A1
(43) Pub. Date: Mar. 3, 2011

(54) ELECTRODE CATALYST COMPOSITION FOR FUEL CELL AND METHOD OF MANUFACTURING THE SAME

(75) Inventors: Jung Ki Park, Daejeon (KR); Wan Keun Kim, Daejeon (KR); Kyung A Sung, Daejeon (KR); Ki Yun Cho, Seoul (KR); In Chul Hwang, Seongnam (KR); Nak Hyun Kwon, Seoul (KR)

(73) Assignee: Hyundai Motor Company, Seoul (KR)

(21) Appl. No.: 12/618,868

(22) Filed: Nov. 16, 2009

(30) Foreign Application Priority Data
Aug. 27, 2009 (KR) 10-2009-0080025

(51) Int. Cl. H01M 4/86; H01M 4/88

(52) U.S. Cl. 429/524; 427/115; 429/535

(57) ABSTRACT

The present invention provides an electrode binder for a polymer electrolyte membrane fuel cell which includes a hydrocarbon-based polymer and a water-soluble polymer acting as a porogen, a porous hydrocarbon-based electrode catalyst layer including the electrode binder, and a method of manufacturing the same. Because of the use of the porogen, the pore size and porosity of the hydrocarbon-based binder catalyst layer are optimized, and bondability of a hydrocarbon-based membrane electrode assembly is enhanced. The present invention also features a fuel cell manufactured using the porogen.

### CROSS-REFERENCE TO RELATED APPLICATION

This application claims under 35 U.S.C. §119(a) the benefit of Korean Patent Application No. 10-2009-0080025 filed Aug. 27, 2009, the entire contents of which are incorporated herein by reference.

### BACKGROUND

(a) Technical Field

The present disclosure relates, generally, to an electrode for a polymer electrolyte membrane fuel cell (PEMFC).

Currently, Nafion is most widely useful as a polymer electrolyte membrane for a PEMFC. Although Nafion has certain advantages such as superior proton conductivity and thermal and electrochemical stability, its proton conductivity is suitably reduced at high temperature (above 80° C.) and it is expensive, thus imposing certain limitations on using it as a polymer electrolyte membrane for a PEMFC.

Accordingly, the development of a hydrocarbon-based polymer electrolyte membrane using a hydrocarbon such as poly(ether ketone), poly(ether sulfone), polyimide, for example, is under thorough investigation. Preferably, the hydrocarbon-based polymer electrolyte membrane has lower fuel permeability and higher proton conductivity at high temperature than does a Nafion membrane, but its fuel cell performance and extended stability are considerably inferior to those of a cell having the Nafion membrane. This is because the hydrocarbon-based polymer electrolyte membrane is considerably incompatible with an electrode having a conventional Nafion binder, thus making it suitably difficult to achieve a stable bonding interface upon fabrication of a membrane electrode assembly (MEA). Accordingly, there is an urgent need to develop a binder adapted for the hydrocarbon-based polymer membrane so as to ensure membrane/electrode interface stability.

Preferably, an electrode catalyst layer suitably manufactured using a hydrocarbon-based polymer binder has a different porous structure and different material transfer properties from those of an electrode catalyst layer having a conventional Nafion binder. Accordingly, research into optimization of an electrode using the hydrocarbon-based polymer binder is required

In the case of the catalyst layer having the conventional Nafion binder, primary and secondary pores are appropriately balanced. However, in the case of the catalyst layer having the hydrocarbon-based polymer binder, this binder excessively infiltrates primary pores unlike Nafion, undesirably decreasing the area of a ternary interface (fuel/electrolyte/catalyst) suitably formed in the primary pores, resulting in reduced catalyst use efficiency. Also, such a pore structure makes it suitably difficult to transfer fuel, and acts as a factor obstructing the discharge of water produced at a cathode, together with the low hydrophobicity of the hydrocarbon-based polymer binder, undesirably deteriorating performance of the fuel cell. Preferably, to manifest the ability to transfer material (hydrogen, oxygen, water) and effectively remove water, the pore size and porosity of the catalyst layer should be optimized.

Further, because the hydrocarbon-based binder has a high glass transition temperature, the bondability between the electrode and the membrane is considerably weakened upon fabrication of the MEA by means of a decal transfer method compared to when using the Nafion binder. Accordingly, there is a demand for the development of an electrode in which bondability of the hydrocarbon-based binder to a hydrocarbon-based membrane is suitably enhanced by lowering the glass transition temperature of the hydrocarbon-based binder.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides, in one aspect, a polymer porogen for suitably optimizing pore size and porosity of a hydrocarbon-based binder catalyst layer and suitably enhancing bondability of a hydrocarbon-based MEA. In other aspects, the present invention provides a fuel cell manufactured using the polymer porogen.

In preferred embodiments, the present invention provides an electrode binder for a PEMFC preferably including a hydrocarbon-based polymer and a water-soluble polymer serving as a porogen.

In another preferred embodiment, the present invention provides a porous hydrocarbon-based electrode catalyst layer that preferably includes the electrode binder.

In still another preferred embodiment, the present invention provides a method of manufacturing the same.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows changes in glass transition temperature of pure polyethyleneglycol, a binder of Example 2 and a binder of Comparative Example 1;

FIG. 2 shows cell performance of the MEAs of Example 7 and Comparative Example 6; and

FIG. 3 shows oxygen reducibility of the MEAs of Example 7 and Comparative Example 6.

It should be understood that the appended drawings are not necessarily to scale and present a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention features an electrode catalyst composition for a fuel cell, comprising a sulfonated hydrocarbon, a porogen, and a Pt catalyst.

In another aspect, the present invention features a porous electrode catalyst layer for a fuel cell, which is manufactured using an electrode catalyst composition comprising a sulfonated hydrocarbon, a porogon and a Pt catalyst and from which the porogen is removed.

In another aspect, the present invention features a method of manufacturing a membrane electrode assembly for a fuel cell, comprising preparing a polymer catalyst slurry composed of a dispersion solvent, a Pt catalyst, a sulfonated hydrocarbon, and polyethyleneglycol; forming a polymer catalyst layer using the polymer catalyst slurry; drying the polymer catalyst layer thus removing the dispersion solvent that remains; bonding the polymer catalyst layer to a membrane, thus manufacturing an membrane electrode assembly; and removing the porogen from the membrane electrode assembly.

In one embodiment, the polymer catalyst slurry is composed of 100 parts by weight of a dispersion solvent, 50˜99 parts by weight of a Pt catalyst, 10˜45 parts by weight of a sulfonated hydrocarbon, and 10˜300 parts by weight of polyethyleneglycol based on 100 parts by weight of the sulfonated hydrocarbon.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In preferred embodiments, the present invention pertains to an electrode binder for a PEMFC composed of a hydrocarbon-based polymer and a water-soluble polymer as a porogen, and to a porous hydrocarbon-based electrode catalyst layer preferably including the electrode binder.

In certain exemplary embodiments, the present invention pertains to an electrode catalyst composition including a sulfonated hydrocarbon, a porogen and a Pt catalyst.

Preferably, the sulfonated hydrocarbon is obtained by sulfonating one or more hydrocarbons selected from the group consisting of, but not necessarily limited to, polysulfone, polyaryleneethersulfone, polyetherethersulfone, polyethersulfone, polyimide, polyimidazole, polybenzimidazole, polyetherbenzimidazole, polyaryleneethyleneketone, polyetheretherketone, polyetherketone, polyetherketoneketone and polystyrene. Further, preferably, as the hydrocarbon, any polymer may be used without being limited to the above examples so long as it has superior proton conductivity. In further preferred embodiments, preferably the sulfonated hydrocarbon functions as a binder.

In certain exemplary embodiments of the present invention, the porogen includes one or more selected from the group consisting of, but not necessarily limited to, polyethyleneglycol, polytetramethyleneglycol, polyacrylamidomethylpropanesulfonic acid, polyacrylic acid, polymethacrylic acid, polyvinylalcohol, polypropyleneglycol and polyhydroxybutyrate, and may also be utilized as a suitable plasticizer for lowering the glass transition temperature of the sulfonated hydrocarbon-based binder. In further preferred embodiments, any polymer material may be used without being limited to the above examples so long as it may function suitably as a porogen. Preferably, the polymer material usable as the porogen may have a number average molecular weight ranging from 200 to 40,000.

In further preferred embodiments, the present invention pertains to a porous electrode catalyst layer for a fuel cell, which is suitably prepared using the electrode catalyst composition including the sulfonated hydrocarbon, the porogen and the Pt catalyst and from which the porogen is removed.

Preferably, because the porous electrode catalyst layer according to the present invention is manufactured using the polymer porogen, the glass transition temperature of the sulfonated polymer binder may be suitably lowered, thus enhancing bondability of a MEA, and also, the pore size and porosity of the hydrocarbon-based binder catalyst layer may be suitably optimized. Such an electrode catalyst layer including the hydrocarbon-based binder is suitably provided in a fuel cell. In particular preferred embodiments, the porogen according to the present invention is soluble in water and is thus easy to remove, and thus preferably advantageously resulting in very high porosity of the binder which thus allows the cell to exhibit superior performance even at high current.

According to further preferred embodiments, the sulfonated hydrocarbon is obtained by sulfonating one or more hydrocarbons selected from the group consisting of, but not necessarily limited to, polysulfone, polyaryleneethersulfone, polyetherethersulfone, polyethersulfone, polyimide, polyimidazole, polybenzimidazole, polyetherbenzimidazole, polyaryleneethyleneketone, polyetheretherketone, polyetherketone, polyetherketoneketone and polystyrene. Preferably, as the hydrocarbon, any polymer may be used without being limited to the above examples so long as it has superior proton conductivity. Preferably, the sulfonated hydrocarbon plays a role as a binder.

According to other further preferred embodiments, the porogen includes one or more selected from the group consisting of, but not necessarily limited to, polyethyleneglycol, polytetramethyleneglycol, polyacrylamidomethylpropanesulfonic acid, polyacrylic acid, polymethacrylic acid, polyvinylalcohol, polypropyleneglycol and polyhydroxybutyrate, and may also be utilized as a plasticizer for lowering the glass transition temperature of the sulfonated hydrocarbon-based binder. Preferably, any polymer material may be used without being limited to the above examples so long as it may function as a suitable porogen. Preferably, polymer material usable as the porogen may have a number average molecular weight ranging from 200 to 40,000.

In certain preferred embodiments, the present invention pertains to a method of manufacturing an MEA for a fuel cell, including suitably preparing a polymer catalyst slurry composed of 100 parts by weight of a dispersion solvent, 50˜99 parts by weight of a Pt catalyst, 10˜45 parts by weight of a sulfonated hydrocarbon, and 10˜300 parts by weight of polyethyleneglycol based on 100 parts by weight of the sulfonated hydrocarbon, suitably forming a polymer catalyst layer using the polymer catalyst slurry, suitably drying the polymer catalyst layer thus removing the residual dispersion solvent, bonding the polymer catalyst layer to a membrane thus manufacturing an MEA, and suitably removing the porogen from the MEA.

In further preferred embodiments of the present invention, the dispersion solvent may be one or more selected from the group consisting of, but not necessarily limited to, methanol, ethanol, isopropylalcohol, dimethylacetamide, dimethylsulfoxide and N-methylpyrrolidone.

According to further preferred embodiments, the polymer catalyst layer is disposed on each of both sides of a proton conductive polymer electrolyte membrane, and then suitably hot pressed, thus manufacturing the MEA. Preferably, the hot pressing process is performed under conditions of a pressure of 500˜4,000 psi and a temperature of 100˜150° C. for 1˜20 min.

Preferably, in the above method, the sulfonated hydrocarbon is obtained by sulfonating one or more hydrocarbons selected from the group consisting of, but not limited only to, polysulfone, polyaryleneethersulfone, polyetherethersulfone, polyethersulfone, polyimide, polyimidazole, polybenzimidazole, polyetherbenzimidazole, polyaryleneethyleneketone, polyetheretherketone, polyetherketone, polyetherketoneketone and polystyrene.

Preferably, in the above method, the porogen includes one or more selected from the group consisting of, but not necessarily limited to, polyethyleneglycol, polytetramethyleneglycol, polyacrylamidomethylpropanesulfonic acid, polyacrylic acid, polymethacrylic acid, polyvinylalcohol, polypropyleneglycol and polyhydroxybutyrate.

### EXAMPLES

The following examples illustrate certain preferred embodiments of the invention and are not intended to limit the same.

### Preparative Example 1

### Preparation of Sulfonated Polyetheretherketone Polymer

In a first example, in order to sulfonate polyetheretherketone (PEEK), 50 ml of 98% conc. sulfuric acid was placed in a 100 ml round-bottom flask and purged with nitrogen, after which 2 g of a PEEK polymer vacuum dried at 100° C. for 24 hours was added thereto and vigorously stirred at a reactor temperature of 50° C. Preferably, the reaction was conducted for 12 hours, after which the reaction product was precipitated in distilled water, and then filtered and thus recovered. The reaction product was washed with water several times in the same manner so that acidity thereof was neutralized, and was then filtered and thus recovered again. The product thus recovered was vacuum dried at 50° C. for 24 hours, thus obtaining a sulfonated PEEK (sPEEK) polymer.

### Preparative Example 2

### Preparation of Polyethyleneglycol/PEEK (=0.5) Binder

In another example, the sPEEK prepared in Preparative Example 1 was used as a polymer binder, and polyethyleneglycol (PEG) was added in an amount 0.5 times the weight of the polymer binder. Thereafter, dimethylacetamide was added thereto so that the amount of the above mixture in the solution was 5 wt %, followed by stirring until completely mixed in a suitably uniform fashion.

### Preparative Example 3

### Preparation of PEG/PEEK (=1.0) Binder

In a further example, the sPEEK prepared in Preparative Example 1 was used as a polymer binder, and PEG was added in an amount 1.0 times the weight of the polymer binder. Thereafter, dimethylacetamide was added thereto so that the amount of the above mixture in the solution was 5 wt %, followed by stirring until completely mixed in a suitably uniform fashion.

### Preparative Example 4

### Preparation of PEG/PEEK (=2.0) Binder

In another example, the sPEEK prepared in Preparative Example 1 was used as a polymer binder, and PEG was added in an amount 2.0 times the weight of the polymer binder. Thereafter, dimethylacetamide was added thereto so that the amount of the above mixture in the solution was 5 wt %, followed by stirring until completely mixed in a suitably uniform fashion.

### Comparative Preparative Example 1

### Preparation of sPEEK Binder

Dimethylacetamide was added so that the amount of sPEEK of Preparative Example 1 was 5 wt %, followed by stirring until completely mixed in a suitably uniform fashion.

### Test Example 1

### Glass Transition Temperature of Binder Membrane

In another example, the binder of each of Preparative Example 3 and Comparative Preparative Example 1 was made uniform, cast on a glass plate using a doctor blade, dried in an oven at 100° C. for 48 hours, and further dried in a vacuum oven at 100° C. for 24 hours, thus forming respective binder membranes.

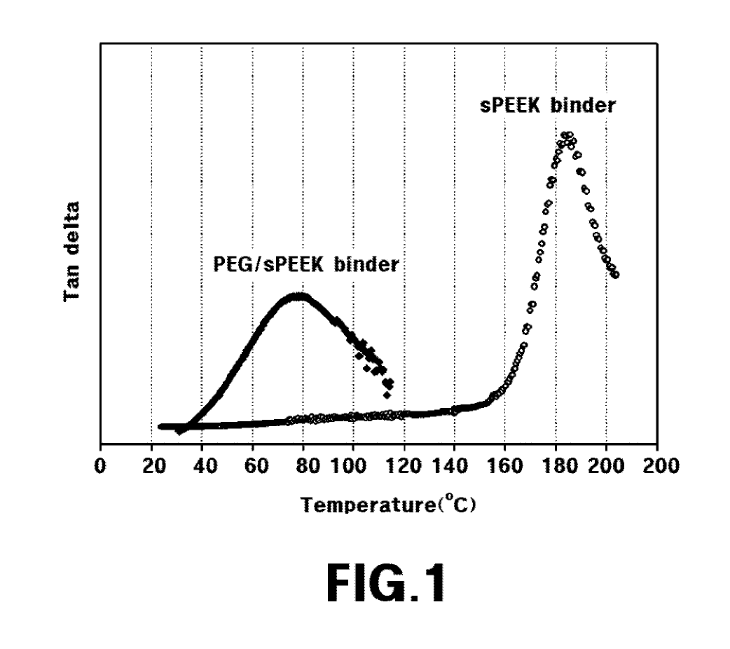

The changes in glass transition temperature of the respective binder membranes and pure PEG were measured. The results are graphed in FIG. 1. As is apparent from the results of FIG. 1, the glass transition temperature of the PEG/PEEK (=1.0) binder of Preparative Example 3 can be seen to be drastically lowered compared to that of the binder of Comparative Preparative Example 1.

Also, the glass transition temperature of PEG can be shown. From FIG. 1, PEG can be seen to function not only as the porogen but also as a plasticizer. Accordingly, an MEA can be more easily manufactured by means of a decal transfer method.

### Example 1

### Preparation of PEG/PEEK Binder Catalyst Ink

In another example, a Pt catalyst (Johnson Matthey, HiSPEC 9100) serving as a cathode catalyst was mixed with the binder solution (5 wt %) of each of Examples 2˜4 so that the amount of cathode binder was 1˜50 wt %. This mixture was added to a dispersion solvent for example dimethylacetamide, stirred and dispersed, thus preparing catalyst ink. The amount of dimethylacetamide was adjusted to be equal to the weight of Pt catalyst and electrode binder (sPEEK).

### Comparative Example 1

### Preparation of Ink Using sPEEK Binder

In a further example, cathode catalyst ink was prepared in the same manner as in Example 1, with the exception that the sPEEK binder of Comparative Preparative Example 1 was used.

### Comparative Example 2

### Preparation of Anode Catalyst Ink Using Nafion Binder

In another example, anode catalyst ink was prepared in the same manner as in Example 1, with the exception that a Nafion binder typical for an anode was used.

### Example 2

### Preparation of Cathode Using PEG/PEEK Binder

In a further example, the catalyst ink of Example 1 was applied in an amount of 0.1˜5 mg/cm² on PTFE-treated carbon paper. The catalyst-applied carbon paper was placed in an oven and dried at 100° C. for 48 hours, thus suitably preparing a cathode.

### Comparative Example 3

### Preparation of Cathode Using sPEEK Binder

In a further example, a cathode was prepared in the same manner as in Example 2, with the exception that the catalyst ink of Comparative Example 1 was used.

### Comparative Example 4

### Preparation of Anode Using Nafion Binder

In a further example, an anode was prepared in the same manner as in Example 2, with the exception that the catalyst ink of Comparative Example 2 was used.

### Preparative Example 5

### Preparation of Mea

In another example, a Nafion-based polymer electrolyte membrane was disposed between the anode prepared in Comparative Example 4 and the cathode prepared in Example 2 and then hot pressed, thus manufacturing an MEA. As such, hot pressing was performed under conditions of 120° C. and 2,000 psi for 15 min.

### Comparative Preparative Example 2

### Preparation of MEA for Comparison

In a further example, an MEA for comparison was manufactured in the same manner as in Preparative Example 5, with the exception that the cathode of Comparative Example 3 was used.

### Test Example 2

### Test of Performance of MEA

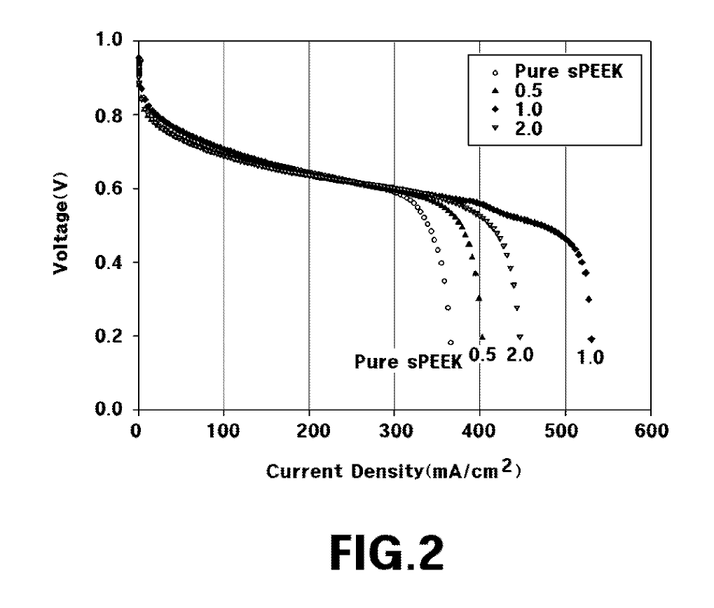

In another example, in order to determine cell performance of the MEA of each of Preparative Example 5 and Comparative Preparative Example 2, changes in voltage depending on current density were measured. As such, the cell was operated under conditions of 30˜90° C., a hydrogen gas supply of 100˜500 ccm, and an oxygen or air supply of 500˜1500 ccm. The results are shown in FIG. 2.

FIG. 2 shows cell performance after the PEG has been removed from the cathode, i.e., after 4˜7 days. As is apparent from the graph of FIG. 2, when PEG was added, cell performance was superior at high current to when using the pure sPEEK binder. This is mainly considered to be because the PEG increased the porosity of the sPEEK binder.

### Test Example 3

### Test of Oxygen Reduction at Cathode of MEA

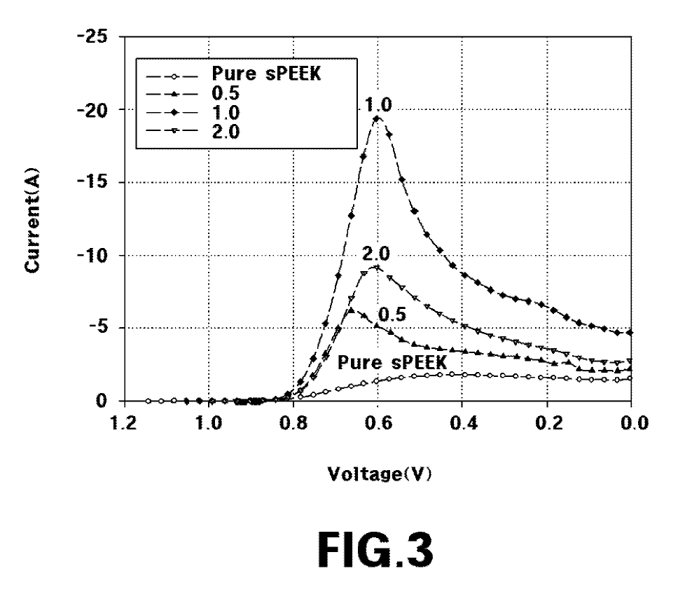

Further, in order to determine oxygen reducibility of the same MEAs as in Test Example 2, while the voltage was decreased to 1.2˜0 V, changes in current density were measured. As such, the cell was operated under conditions of 30˜90° C., a nitrogen gas supply of 10˜100 ccm to the anode, and an oxygen or air supply of 10˜100 ccm. The results are shown in FIG. 3.

As shown in the graph of FIG. 3, when PEG was added, cell performance was superior over the entire range compared to when using the pure sPEEK binder. In particular, in the range of 0.2˜0.7 V, cell performance was comparatively superior.

As described by the preferred aspects and embodiments of the present invention, a water-soluble polymer is suitably used as a porogen. Accordingly, in a fuel cell including an electrode catalyst layer having a hydrocarbon-based polymer binder, because of the use of the polymer porogen, the glass transition temperature of the sulfonated polymer binder can be suitably lowered, thus enhancing bondability of an MEA, and furthermore, the pore size and porosity of the hydrocarbon-based binder catalyst layer can be suitably optimized.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An electrode catalyst composition for a fuel cell, comprising a sulfonated hydrocarbon, a porogen, and a Pt catalyst.

2. The electrode catalyst composition of claim 1, wherein the sulfonated hydrocarbon is formed by sulfonating one or more hydrocarbons selected from the group consisting of polysulfone, polyaryleneethersulfone, polyetherethersulfone, polyethersulfone, polyimide, polyimidazole, polybenzimidazole, polyetherbenzimidazole, polyaryleneethyleneketone, polyetheretherketone, polyetherketone, polyetherketoneketone and polystyrene.

3. The electrode catalyst composition of claim 1, wherein the porogen comprises one or more selected from the group consisting of polyethyleneglycol, polytetramethyleneglycol, polyacrylamidomethylpropanesulfonic acid, polyacrylic acid, polymethacrylic acid, polyvinylalcohol, polypropyleneglycol and polyhydroxybutyrate.

4. A porous electrode catalyst layer for a fuel cell, which is manufactured using an electrode catalyst composition comprising a sulfonated hydrocarbon, a porogon and a Pt catalyst and from which the porogen is removed.

5. The porous electrode catalyst layer of claim 4, wherein the sulfonated hydrocarbon is formed by sulfonating one or more hydrocarbons selected from the group consisting of polysulfone, polyaryleneethersulfone, polyetherethersulfone, polyethersulfone, polyimide, polyimidazole, polybenzimidazole, polyetherbenzimidazole, polyaryleneethyleneketone, polyetheretherketone, polyetherketone, polyetherketoneketone and polystyrene.

6. The porous electrode catalyst layer of claim 4, wherein the porogen comprises one or more selected from the group consisting of polyethyleneglycol, polytetramethyleneglycol, polyacrylamidomethylpropanesulfonic acid, polyacrylic acid, polymethacrylic acid, polyvinylalcohol, polypropyleneglycol and polyhydroxybutyrate.

7. A method of manufacturing a membrane electrode assembly for a fuel cell, comprising:
preparing a polymer catalyst slurry composed of 100 parts by weight of a dispersion solvent, 50˜99 parts by weight of a Pt catalyst, 10˜45 parts by weight of a sulfonated hydrocarbon, and 10˜300 parts by weight of polyethyleneglycol based on 100 parts by weight of the sulfonated hydrocarbon;
forming a polymer catalyst layer using the polymer catalyst slurry;
drying the polymer catalyst layer thus removing the dispersion solvent that remains, and then bonding the polymer catalyst layer to a membrane, thus manufacturing an membrane electrode assembly; and
removing the porogen from the membrane electrode assembly.

8. The method of claim 7, wherein the dispersion solvent comprises one or more solvent selected from the group consisting of methanol, ethanol, isopropylalcohol, dimethylacetamide, dimethylsulfoxide and N-methylpyrrolidone.

9. The method of claim 7, wherein the sulfonated hydrocarbon is formed by sulfonating one or more hydrocarbons selected from the group consisting of polysulfone, polyaryleneethersulfone, polyetherethersulfone, polyethersulfone, polyimide, polyimidazole, polybenzimidazole, polyetherbenzimidazole, polyaryleneethyleneketone, polyetheretherketone, polyetherketone, polyetherketoneketone and polystyrene.

10. The method of claim 7, wherein the porogen comprises one or more porrogen selected from the group consisting of polyethyleneglycol, polytetramethyleneglycol, polyacrylamidomethylpropanesulfonic acid, polyacrylic acid, polymethacrylic acid, polyvinylalcohol, polypropyleneglycol and polyhydroxybutyrate.

11. A method of manufacturing a membrane electrode assembly for a fuel cell, comprising:
preparing a polymer catalyst slurry composed of a dispersion solvent, a Pt catalyst, a sulfonated hydrocarbon, and polyethyleneglycol;
forming a polymer catalyst layer using the polymer catalyst slurry;
drying the polymer catalyst layer thus removing the dispersion solvent that remains;
bonding the polymer catalyst layer to a membrane, thus manufacturing an membrane electrode assembly; and
removing the porogen from the membrane electrode assembly.

12. The method of claim 11, wherein the polymer catalyst slurry is composed of 100 parts by weight of a dispersion solvent, 50˜99 parts by weight of a Pt catalyst, 10˜45 parts by weight of a sulfonated hydrocarbon, and 10˜300 parts by weight of polyethyleneglycol based on 100 parts by weight of the sulfonated hydrocarbon.
